(19) United States
(12) Patent Application Publication
(10) Pub. No.: US 2015/0369565 A1
(43) Pub. Date: Dec. 24, 2015

(54) Optical Device Having a Light Separation Element

(71) Applicant: Matthew Flint Kepler, Austin, TX (US)

(72) Inventor: Matthew Flint Kepler, Austin, TX (US)

(21) Appl. No.: 14/309,909

(22) Filed: Jun. 20, 2014

(51) Int. Cl. F41G 1/38; F41G 3/06; H04N 7/18

(52) U.S. Cl. CPC F41G 1/38; H04N 7/183; F41G 3/06

(57) ABSTRACT

An optical device, such as a firearm scope or telescope, may comprise an aperture to receive light, and a light separation element to split the light received from the aperture into a plurality of light paths directed to a plurality of sensors. Sensors may include bright light sensors, low light sensors, range-finder sensors, or other sensors. The light may be separated and directed to the various sensors using prisms, light filters, mirrors, or any combination thereof. The optical device may include circuitry configured to generate image data, determine range data, perform a ballistics calculation, or to perform other operations based on the plurality of sensors.

### FIELD

The present disclosure is generally related to optical devices, such as rifle scopes and telescopes, having a light separation element.

### BACKGROUND

Portable optical devices such as rifle scopes, spotting scopes, cameras, and telescopes may offer a variety of features, such as high resolution images, a high zoom ratio, low-light capability, or range-finding functionality. It is common for optical devices offering a variety of features, such as laser range finding, to include sensors configured to receive light through multiple apertures.

### SUMMARY

In some embodiments, an apparatus may comprise an optical device including an aperture to receive light, a light separation element (LSE) configured to separate the light received from the aperture into at least a first light output directed to a bright light sensor and a second light output directed to a low light sensor, and circuitry configured to generate first image data based on the first light output at the bright light sensor, and generate second image data based on the second light output at the low light sensor.

In some other embodiments, a firearm scope may comprise a range-finder transmitter configured to transmit light toward a view area, an aperture configured to receive light, including reflected light from an object within the view area, and a light separation element (LSE) configured to separate the received light into at least a first light portion and a second light portion, direct the first light portion to a range-finder sensor, and direct the second light portion to a first imaging sensor.

In still other embodiments, a method may comprise transmitting light at a selected frequency from a transmitter of a firearm scope toward a view area of the firearm scope, receiving light at the firearm scope from the view area through an aperture, the received light including reflected light corresponding to the light of the selected frequency reflected by an object in the view area, separating the received light into a first output portion and a second output portion, the first output portion including the reflected light, directing the first output portion to a first sensor and the second output portion to a second sensor, generating image data based on data from the second sensor, and providing the image data to a display of the firearm scope.

### BRIEF DESCRIPTION OF THE DRAWINGS

FIG. 1 is a perspective view of an optical device having a light separation element according to some embodiments.

FIG. 2 is a perspective view of a small arms firearm including an optical device having a light separation element according to some embodiments.

FIG. 3 is a block diagram of a portion of an optical device having a light separation element according to some embodiments.

FIG. 4 is a block diagram of an optical device having a light separation element according to some embodiments.

FIG. 5 is a front view of an optical device having a light separation element according to some embodiments.

FIG. 6 is a block diagram of circuitry of an optical device having a light separation element according to some embodiments.

FIG. 7 is a flow chart of a method of receiving light at an optical device having a light separation element according to some embodiments.

In the following drawings, reference numbers may be reused to indicate the same or similar elements.

### DETAILED DESCRIPTION OF ILLUSTRATIVE EMBODIMENTS

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

In some embodiments it may be desirable for an optical device to have multiple light or image capturing functions or modes. For example, it may be desirable for a portable optical device such as a digital rifle scope to include zoom functionality, high resolution normal light functionality, low light functionality, multispectral capability, active illumination, and range-finding functionality, such as by using a laser range finder (LRF) or flash LiDAR (Light Detection and Ranging). In order to achieve a high zoom ratio and high resolution, sensors with many pixels (e.g. 10+ Megapixels, (MP)) utilizing small pixel pitch (e.g., 1.4 μm) can be used. Unfortunately, such small pixel sizes may provide very little active area for gathering light and, as a result, low light capability may suffer. In order to provide low light sensitivity, pixel sizes can be increased, faster lenses may be used (e.g. lenses having a lower f-number, sometimes denoted “f#,” referring to a ratio of a lens' focal length to the diameter of the entrance pupil, which ratio may be used as a measure of lens speed), or both. However, to maintain high zoom and high resolution, the focal length and size of the lens may increase in proportion to the pixel size, leading to designs with long focal lengths and large entrance pupil diameters. The lenses for such designs can be large, heavy, and expensive, and may increase the size of the optical device.

Embodiments of an optical device, such as a telescope, spotting scope, or a rifle scope, are described below that a light separation element. In some embodiments, the optical device includes a light separating element configured to split received light into multiple light paths, each of which may have an associated optical sensor. In some embodiments, the optical device may have multiple optical sensors, where each optical sensor is configured to sense light in a particular range of frequencies, in a particular range of illumination levels (e.g. low light, bright light, and so on), or any combination thereof.

Embodiments of the optical device described below can provide high resolution, high zoom ratio, low light capability, and additional functions through the use of two or more optical sensors. The optical sensors may be referred to as light sensors, image sensors, or range-finding sensors, light receivers, or using similar terminology. For example, range-finding sensors may be used to capture light reflected from an object in a view area of the optical device for range-finding calculations, while image sensors may be used to capture light corresponding to images of the view area. The multiple optical sensors may include a first image sensor configured for daytime or bright light and having a multi-megapixel format and a small pixel pitch. The image sensor may utilize a charge-coupled device (CCD), complementary metal oxide semiconductor (CMOS) technology, or other technology. The multiple optical sensors may further include a second image sensor having fewer pixels, and a larger pixel pitch for increased low light sensitivity as compared to a first image sensor. Such a sensor may utilize CCD technology, CMOS technology, Intensified CCD (ICCD) technology, electron-multiplying (EMCCD) technology, electron-bombarded CCD (EBCCD) technology, or other low-light enhancing technology. The multiple optical sensors may further include range finder sensors, which may be configured for a pre-determined frequency range, such as a frequency corresponding to a reflected laser beam. In some embodiments, the optical sensors may also include infrared sensors configured to capture optical data within a range of optical wavelengths such as near infrared radiation or thermal radiation.

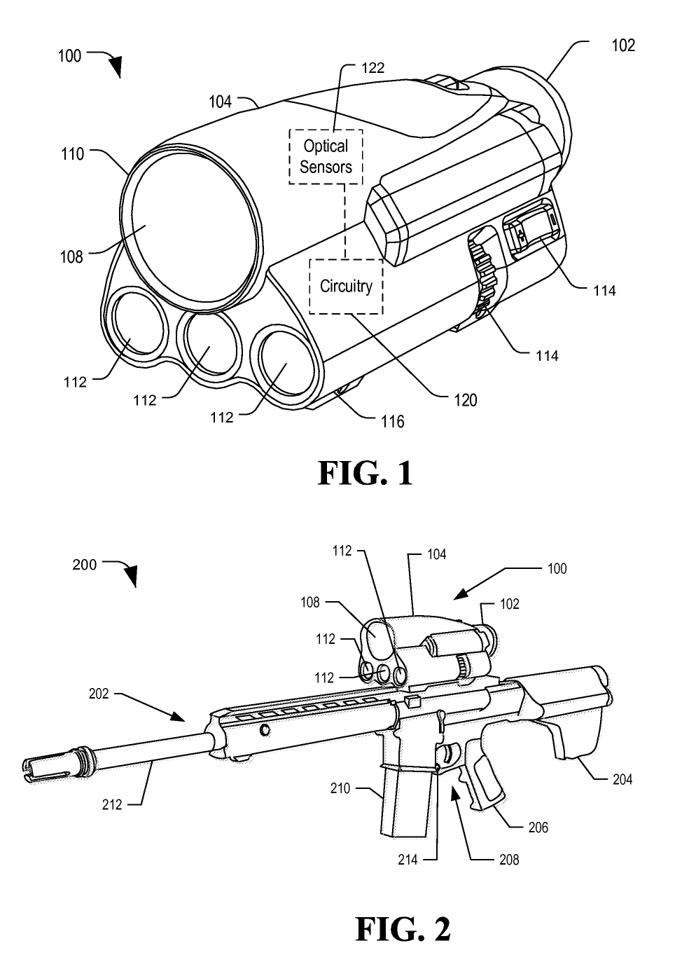

Light may be received through an aperture and may be directed to the multiple optical sensors by splitting or separating light into multiple paths. In some embodiments, light received through an objective lens or aperture may be split or separated according to different wavelength ranges, according to a neutral density split, according to a spectral light split, or a combination thereof. Light may be separated or split into multiple independent light paths or light beams using a light separating element (LSE). An LSE may include one or more prisms, filters, mirrors, or any combination thereof. The split light beams may be directed to different receivers or sensors within the optical device. In some embodiments, an optical device may direct received light to an LSE using a focusing lens, and the LSE may split the received light into a first light output directed to a first sensor, a second light output directed to a second sensor, and a third light output directed to a third sensor. In some embodiments, the first sensor may be a bright light (e.g. daylight) sensor, the second sensor may be a low light (e.g. nighttime) sensor, and the third sensor may be a range-finding sensor configured to sense reflected laser light. Other configurations and embodiments are also possible. One example of an optical device is described below with respect to FIG. 1.

FIG. 1 is a perspective view of an optical device 100 having a light separation element according to some embodiments. In an embodiment of FIG. 1, the optical device 100 may comprise a gun scope, which can be mounted to a firearm such as a rifle. Optical device 100 includes circuitry 120, which can include or be coupled to optical sensors 122. In some embodiments, optical sensors 122 and circuitry 120 may be included on a single circuit board, or they may be separate circuits which may be communicatively coupled.

Optical device 100 can include an optical element 110 including a lens portion 108 for focusing light toward light sensors 122. Lens portion 108 may include an objective lens, and optionally may include additional focusing lenses (not shown) in-line with the objective lens. Optical device 100 may further include additional lenses or apertures 112. In some embodiments, optical device 100 may include transmitters (not shown) to transmit illumination, lasers, electron beams (e-beams), or other transmissions through one or more of the apertures 112. In some embodiments, one or more of the apertures 112 may focus light or thermal data towards additional sensors, which may be located behind one of the one or more apertures 112.

Optical device 100 can include an eyepiece 102 through which a user can view a display associated with circuitry 120. Components 114 for receiving user input and adjusting device settings may be included on optical device 100. The components 114 can include buttons, rocker switches, wheels, other user-accessible elements, or any combination thereof. Optical device 100 may further include a housing 104 that defines an enclosure sized to secure the lens(es) 108 and 112, optical sensors 122, and circuitry 120. Circuitry 120 may include processors, controllers, light and image manipulating components, laser rangefinder circuitry, and circuits configured to digitally magnify and process optical data captured by the optical sensors 122. Further, housing 104 may also secure one or more LSEs to separate light received through lens 108. Additionally, optical device 100 can include a mounting structure 116 configured to couple the optical device to an external device, such as a firearm or tripod. In some embodiments, mounting structure 116 may include connections to allow circuitry 120 of optical device 100 to communicate with or control circuitry or functions of the external device. For example, the optical device may be configured to provide signals to a trigger assembly to control the firing mechanism of a firearm.

Circuitry 120 may include logic circuitry such as a digital signal processor (DSP), a microprocessor unit (MCU), communications logic, other circuits, or any combination thereof. Further, circuitry 120 may include motion and orientation data sensors. Circuitry 120 may be configured to format the captured optical data into a viewable image for presentation on a display that may be viewed through the eyepiece 102, stored to a data storage medium, or transmitted through wired or wireless means to an external device, or any combination thereof. For example, circuitry 120 may include a wireless transmitter configured to send image data, text data, audio data, other data, or any combination thereof. In an example, the destination device can be another optical device that has another instance of circuitry 120, such as a spotting scope being used in conjunction with the optical device 100. In another embodiment, the destination device may be a computing device such as a desktop computer, a laptop computer, a tablet computing device, a smart phone, another device, or any combination thereof.

In some embodiments, circuitry 120 and optical sensors 122 may capture image data associated with a view area of optical device 100. For example, image data may include light received through objective lens 108, including natural light and reflected light. The reflected light may be light that was transmitted (such as by a laser beam) by the optical device 100 (e.g. using a transmitter associated with an aperture 112) towards the view area, which transmitted light was reflected by an object within the view area. In some embodiments, the reflected light may include infrared light, LRF laser light, other reflected light, or a combination thereof. The received light may be directed to a light separation element (not shown), which may split the light into separate paths directed to multiple optical sensors 122.

Optical device 100 of FIG. 1 can be any type of optical device, including a firearm scope, a spotting scope, a telescope, a camera, a pair of binoculars, another device, or any combination thereof. In some embodiments, optical device 100 may include a firearm scope which can be mounted to a firearm. In some embodiments, at least some of the circuitry 120 of the optical device 100 may be included in the firearm. In an example, the power supply may be located in the stock of the firearm. Additionally, other circuits may be distributed between the optical device 100 and the firearm. An example of an optical device 100 mounted to a firearm is described below with respect to FIG. 2.

FIG. 2 is a perspective view of a firearm system 200 including the optical device 100 of FIG. 1, according to some embodiments. The optical device 100 may be mounted to or integrated with a portion of the housing of a firearm 202. The firearm 202 may include a stock 204, a grip 206, a trigger assembly 208, a clip 210, and a muzzle 212. The firearm 202 may include one or more buttons or switches, such as button 214, which may be accessed by a user. The button 214 may be coupled to circuitry 120 and may be accessed by the user to access functionality of the optical device 100. For example, a user may be able to control functions of the optical device 100 by manipulating controls located on the firearm 202. In some embodiments, a user may be able to use button 214 in order to “tag” or select an object within the view area of the optical device 100 as a target. In response to target selection, the optical device 100 may determine a range to the selected target and may use circuitry 120 to calculate a ballistics solution for the target. Circuitry 120 may prevent firearm 202 from discharging until the ballistics calculations show that the shot will impact within a threshold distance from the tagged location on the target, for example by selectively preventing discharge of the firearm in response to the user pulling trigger 208 until the ballistic aim point is aligned to or predicted to be aligned with the tagged location.

In some embodiments, circuitry for image processing or other functions of the optical device 100 may be located within the firearm 202. For example, the optical device 100 and the firearm 202 may be integrated, so that at least some of the circuitry used by the optical device 100 may be located within the firearm 202. For example, circuitry for image processing data calculations, ballistics calculations, range calculations, other operations, or a combination thereof may be located in the grip 206, the stock 204, or in other parts of firearm 202. In some embodiments, a power source for the optical device 100 may be located within the firearm 202, such as in the stock 204. The embodiments of the optical devices 100 depicted in FIG. 1 and FIG. 2 are merely exemplary, and optical devices may include other implementations, such as telescopes, spotting scopes, binoculars, viewfinders, and the like.

In some embodiments, the optical device 100 may include a plurality of optical sensors, which may share an objective lens or an aperture. The objective lens may be a lens assembly that may include one or more lenses aligned between the entrance aperture and an LSE. The LSE may receive light through the lens (or lens assembly) and may separate the light into multiple light paths, each of which may include one or more associated optical sensors. The LSE can utilize a neutral density split (i.e. splitting light across all wavelengths according to a given proportion, such as 50/50 or 70/30), a spectral split (e.g. splitting the light according to light wavelengths, such as using a dichroic or trichroic prism or filter), or a combination thereof. In some embodiments, the LSE may include a beam splitter cube with a half silvered hypotenuse to separate light into two beams at a neutral density ratio, such as an 80:20 ratio, a 70:30 ratio, or a 90:10 ratio. For example, in the 80:20 ratio implementation, eighty percent of the light may be directed to a first sensor, and twenty percent of the light may be directed to a second sensor. In some embodiments, a daytime sensor may be used when scene illumination levels are in the 10-100 k lux range, i.e. where light is plentiful. A nighttime sensor may be used for illumination levels of 0.001-10 lux. In some embodiments, the LSE may direct a larger portion of the light to the low light sensor, and may direct a smaller portion of the light to the bright light sensor. In some embodiments, the device may benefit from a lens with a long back working distance (distance from the last lens in the objective to the focal plane), providing high-level correction for chromatic aberration and allowing for greater space to implement and integrate a LSE.

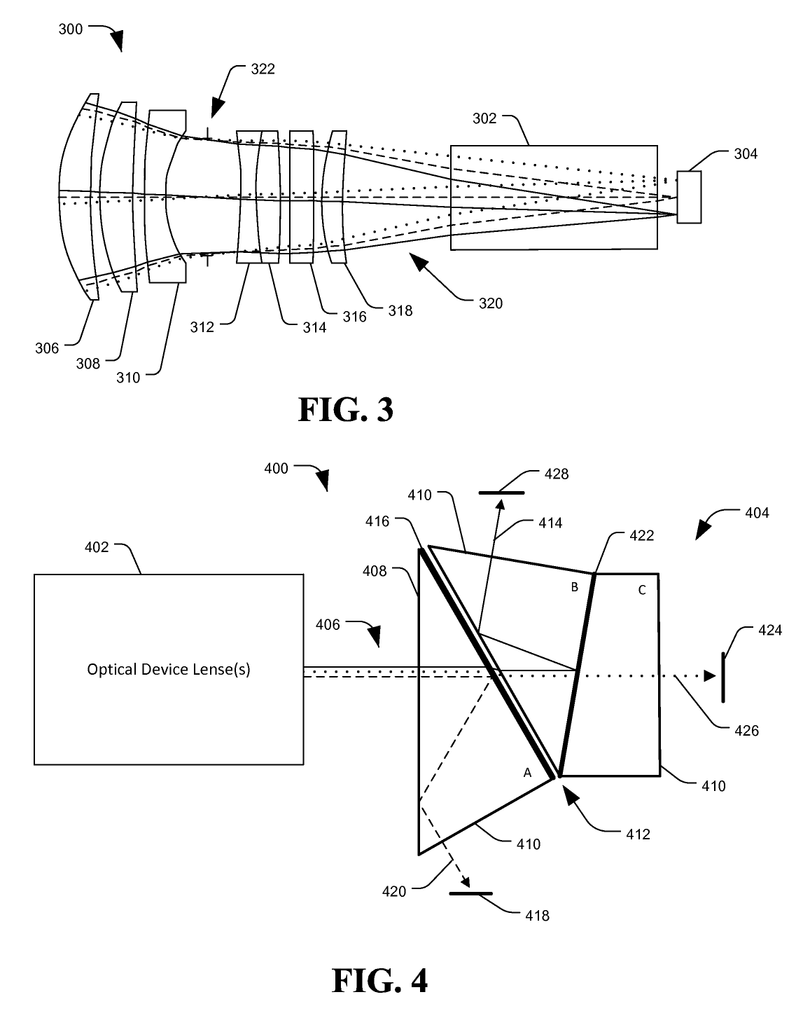

In some embodiments, the lens portion may include multiple lenses to focus light. An example of a portion of an optical device include multiple lenses, according to some embodiments, is described below with respect to FIG. 3.

FIG. 3 is a block diagram of a portion of an optical device (generally designated 300) having a light separation element, according to some embodiments. FIG. 3 depicts a representative example of an objective lens assembly and an LSE 302, which may be used within the optical device 100 in FIGS. 1 and 2, and which may be configured to split the received light into multiple light paths. Each light path may provide a portion of the received light to one of a plurality of sensor circuits 304a, 304b, and 304c. It should be understood that each of the sensor circuits 304a, 304b, and 304c may include one or more optical sensors.

In the illustrated example, the objective lens assembly includes multiple optical elements: 306, 308, 310, 312, 314, 316, and 318. However, additional or fewer elements may be used in some embodiments. In an example embodiment, at least some of the lenses may have spherical surfaces (e.g. to control cost), while a surface of lens 306 may use an aspheric surface (e.g. to control spherical aberration). The optical device 300 may include an LSE 302 (shown in block form), which may be configured to separate or split light 320 into separate light paths, which may be directed to separate detectors or sensors 304a, 304b, and 304c, such as daytime and nighttime image sensors, range-finding sensors, other sensors, or any combination thereof. While three sensors are shown in the illustrative embodiment, more or fewer sensors may be used in some embodiments. Further, sensors may be incorporated on a single circuit board or may be included in separate circuit boards. In some embodiments, each sensor may be optically isolated, such as by using physical dividers or walls (not shown).

In some embodiments, a total length of the objective lens variant may be approximately 150 mm (5.9″) from lens 306 to image sensors 304a, 304b, and 304c. The focal length may be 120 mm, and the pupil 322 may be the aperture at which the f-number is calculated. In some embodiments, the pupil 322 may have an f-number of 2.8 (f/2.8). An f-number of 2.8 provides a good balance between high brightness, performance, and cost. In some embodiments, lens 306 may have a front element diameter of 50 mm (2″), with subsequent lenses of lesser diameter.

In some embodiments, an adjustable aperture 322 may be provided within the lens assembly, which aperture 322 can be adjusted by the user to adjust the f-number. In an example, the user may reduce the f-number by constricting the aperture 322, such as in daylight conditions, to improve contrast on the daytime image sensor. In some embodiments, an adjustable aperture 322 may be located between the third lens element 310 and the fourth lens element 314 as shown. In other embodiments, the aperture 322 may be located at a different stage within the lens sequence.

The combination of the objective lens assembly, optical sensors, and display optics can determine the zoom ratio, resolution and native zoom capability for the optical device 300. In one possible embodiment, the sensor pixels may be displayed to the user via the display 616 and eyepiece 102 at 1.5 MOA (Minutes of Angle) per pixel in the native format. An example set of parameters for some embodiments of the optical device 100 is provided in the following table:

| | Daytime | Nighttime |
|---|---|---|
| Parameter | Sensor | Sensor |
| Field of view per pixel (MOA) | 0.0401 | 0.1604 |
| Native magnification | 37.4 | 9.35 |
| Minimum magnification | 5.44 | 6.23 |
| Maximum mag (w/ 25% interpolation) | 46.75 | 11.68 |
| Horizontal FOV (field of view) (ft@100 yd) | 14.71 | 17.11 |
| Vertical FOV (ft@100 yd) | 11.03 | 9.63 |
| Zoom ratio | 6.8x | 1.5x |

In some embodiments, the daytime sensor may provide a magnification range of approximately 6-37×. The nighttime sensor may provide a magnification range of approximately 6.2-9.3×. By utilizing interpolation to infer pixel values for a lower resolution nighttime sensor, the zoom range of the night sensor can be increased. For example, with an interpolation of 25%, the night zoom may be increased to approximately 6.2-12×.

Various sensors may be used which meet the desired parameters for the optical device, such as pixel size and sensitivity to a desired light frequency spectrum. An illustrative embodiment of a daytime sensor which may be used with the optical device 100 is manufactured by Omnivision® Technologies, Inc, of Santa Clara, Calif., part number designator OV14810. An illustrative embodiment of a night capable sensor which may be used with the optical device 100 is manufactured by SiOnyx® Inc., of Woburn, Mass., part number designator XQE-0920. The following table captures a number of relevant parameters of the two sensors:

| Parameter | Daytime Sensor | Nighttime Sensor |
|---|---|---|
| Manufacturer | Omnivision ® | SiOnyx ® |
| Active pixels | 4400 × 3300 | 1280 × 720 |
| Pixel size | 1.4 μm | 5.6 μm |
| Frame rate | 54 Hz | 60 Hz |
| Sensitivity Spectrum | 400 nm-650 nm | 400 nm-1100 nm |
| Active area diagonal size | 7.7 mm | 8.2 mm |

It should be understood that the example sensors identified in the above tables provide 37× magnification in daylight conditions and lower magnification in low light conditions. These sensors represent a tradeoff between performance and cost. Other sensors may be used, depending on the desired performance specifications.

In some embodiments, the optical device 100 may include an integrated laser range finder (LRF), an integrated LiDAR, other range-finding technology, or a combination thereof. For example, an LRF may include a transmitter to emit a laser beam, which transmitter may be positioned behind one or more of the apertures 112 in FIG. 1. The LRF may further include a receiver or sensor to detect the reflected laser light and to generate a signal proportional to the reflected laser light from which signal a range value may be determined. In some embodiments, the LRF may include a low cost 905 nm system. Rather than using a dedicated receiver aperture, the LRF can use the same aperture used to receive light for imaging purposes, such as lens 108 of FIG. 1.

For example, a large objective lens (e.g. a 2″ diameter lens with a 6″ focal length) used for image data collection can occupy a majority of the volume of a scope. The inclusion of such a large lens may allow little remaining volume for additional apertures, especially large receiver apertures that are often used for LRF or other range-finding systems for long range applications. Therefore, it may be advantageous to use the large objective lens for the LRF in addition to receiving light for image data collection. By taking advantage of the same objective lens (e.g. 50 mm diameter) for image data collection and for collecting laser light reflected from targets, the signal-to-noise ratio can be increased, thus extending the maximum LRF range capability. The large receiver aperture may also permit the use of a smaller laser transmit aperture (e.g. aperture 112 of FIG. 1), further reducing volumetric requirements of the LRF subsystem and the optical device 100 in general. Configuring the LRF receive channel to receive light through the large objective lens assembly can be accomplished via the LSE 302, which can also be used to split light to the image sensors.

Turning now to FIG. 4, a diagram of a portion of an optical device having a light separation element, according to some embodiments, is shown and generally designated 400. The optical device 400 may include one or more lenses 402 to receive light 403 through a single aperture, and to focus the light, in focused light path 406, toward an LSE 404. The LSE 404 may be designed to split the light 406 into multiple light paths 414, 420, and 426, which may be associated with different light sensor circuits 428, 418, and 424, respectively. Each light sensor circuit 428, 418, and 424 may include one or more optical sensors. In some embodiments, the light sensor circuits 428, 418, and 424 may include photodiode sensors such as an APD (avalanche photodiode), which can convert light into electricity.

In the depicted embodiment, LSE 404 includes a separation prism, such as a three channel splitter having more complex geometry than a simple cube splitter. The three channel splitter 404 may include prism A, prism B, and prism C, structured and arranged to split and direct light along three desired paths 414, 420, and 424. LSE 404 may split the received light using neutral density separation at a selected proportion across all wavelengths or a given range of wavelengths, split the received light into different wavelengths, or a combination thereof. The split light may be directed toward multiple sensors, including, for example, a day sensor, a night sensor, an LRF sensor, other sensors, or a combination thereof. In some embodiments, LSE 404 may include a modified 3-channel trichroic Phillips type beam splitter prism. While a three channel splitter is shown in the illustrative embodiment of FIG. 4, it should be understood that LSEs configured to separate light into more or fewer channels may be used in some embodiments.

In the illustrative example, LSE 404 can separate the single light input 406 into three light channels or paths. The design lends itself to operation in a convergent or divergent input without introducing astigmatism due to the perpendicularity of input surface 408 and exit surfaces 410 of the LSE 404. The LSE 404 includes an air gap 412 between prism A and prism B, which air gap 412 may be used to accomplish total internal reflection (TIR) of the solid line light path 414. The air gap 412 may also allow for a more complex notch filter 416 to be placed on the exit surface of prism A. A notch filter is a type of band-stop or band-rejection filter, which can allow some light frequencies to pass unaltered, while reducing or deflecting other wavelengths. Other optical filters, or a combination thereof, may also be used. For example, notch filter 416 can provide the split for the LRF receiver wavelength of, e.g. approximately 905 nm+/−20 nm. The LRF receiver 418 can be positioned at the output 410 through which the light path (indicated by dashed line 420) exits prism A.

The remainder of the light (e.g., approximately 400 nm-1200 nm, less the LRF band of approximately 880-920 nm) may pass into prism B, where a neutral density (ND) filter 422 of dielectric or partially metalized coating (for example) may be applied to the surface between prism B and prism C. The ND filter may cause a fraction of the light (e.g. 10, 20, or 30%) to be deflected as indicated by solid line 414, while the remainder of the light may pass through as indicated by dotted line 426. In some embodiments, a night sensor 424 may be positioned in the light path represented by dotted line 426, thereby receiving a portion of the received light that is of a frequency range outside the LRF range. Further, a daytime sensor 428 may be positioned in the light path represented by solid line 414, thereby receiving a remaining portion of the light outside the LRF range. Additional coating may be applied at filter 422 to include enhanced spectral transmission, for example in the approximately 650-1200 nm band, which may be utilized by the night sensor 424, but not by the day sensor 428. A coating on the exit surface 410 of prism B can be applied to act as a permanent and integrated infra-red (IR) cut filter (e.g. to block infrared light wavelengths while allowing light from the visible light spectrum of approximately 400-650 nm to pass). In some embodiments, a color filter made of absorptive glass may also be used to suppress unwanted wavelengths from reaching the daytime color sensor.

In some embodiments, light can be split based on wavelengths, neutrally, or a combination thereof. For example, the day sensor 428 may be configured to only receive light in the 400-650 nm wavelength spectrum, while night sensor 424 may be configured to receive light in the 400-1200 nm spectrum. The LSE 404 may be configured to direct all light in the 650 nm-1200 nm spectrum toward the night sensor 424, and to neutrally split light in the 400-650 nm spectrum at a set ratio, such as 70% to the night sensor 424 and 30% to the day sensor 428. In another embodiment, identical or similarly configured sensors may be used for both the “day” and “night” sensors, with, for example, a 70/30, 80/20, or 90/10 neutral density split to the night sensor 424 and day sensor 428, respectively. This neutral split approach could be used to create an HDR (high dynamic range) video image, for example. Other configurations are also possible.

In some embodiments, the day sensor 428 may be sensitive to the 400-650 nm range, while the night sensor 424 may be sensitive to the 800-1500 nm range, in which case splitting the light based purely on wavelength may be desirable. It should be noted that the illustrative embodiment of LSE 404 depicted in FIG. 4 is merely exemplary, and an LSE configured to split additional or fewer light wavelengths, different wavelengths, or to neutrally separate light at different ratios may also be used without departing from the scope of the present disclosure. Further, the split light may be redirected along a desired light path. Similarly, an LSE configured to separate light into more or fewer light paths directed to one or more sensor circuits may also be used.

In some embodiments, LSE 404, LRF receiver 418, and image sensors 424 and 428 can be aligned, epoxied, and potted as a sub-assembly and later integrated into the optical device as a complete unit. Subsystem pre-assembly can make manufacturing easier, since it does not require that each device be aligned within the potentially tight physical constraints of the optical device housing.

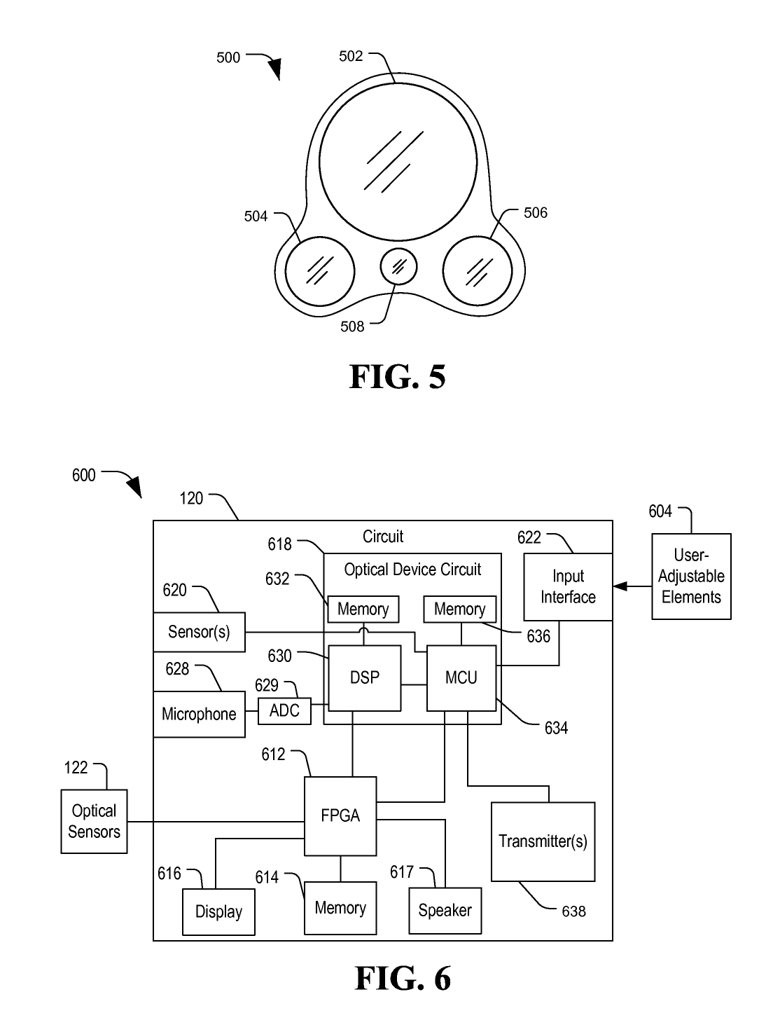

FIG. 5 is a front view of an optical device having a light separation element, according to some embodiments and generally designated 500. The optical device 500 is one possible implementation of the optical device 100, according to some embodiments. In the depicted embodiment, the optical device 500 may include a receiving lens 502, such as a large objective lens. The optical device 500 may also include one or more apertures through which transmitters may emit light, such as an aperture 504 for a LRF transmitter, an aperture 506 for an illuminator transmitter, and an aperture 508 for a possible third transmitter. In some embodiments, one or more of the apertures 504, 506, and 508 may be used for receivers or sensors, such as a thermal sensor. In some embodiments, multiple transmitters may be configured to utilize the same transmitter aperture. In some embodiments, the transmitters and the optical sensors could utilize the same aperture, such as an optical device having an aperture for both transmission and reception of light.

The system 500 may include three primary apertures. The first aperture 502 may include (and be sealed by) an objective lens having a diameter of approximately 50 mm and that may be used as the imaging optic for multiple sensors, such as a day sensor and a night sensor. An LRF sensor or other range-finding sensor may receive light through aperture 502. In some embodiments, an LRF transmitter aperture 504 may be approximately 25 mm in diameter, and an infrared illuminator aperture 506 may also be approximately 25 mm in diameter. Aperture 508 may be used for additional transmitters or receivers, such as for a LiDAR transmitter, a LiDAR receiver or sensor, other circuits, or any combination thereof. The sizes, positions, and number of the apertures may be chosen based on appearance, weight, cost, performance goals, and desired functionality for the optical device 500, or based on other considerations.

In some embodiments the LRF aperture 504 may be on the order of approximately 20-25 mm diameter, and approximately 75 mm long, yielding an f-number of between approximately f/3 and f/3.75. The LRF may have a full divergence angle of approximately 3 mrad (milliradians). Smaller transmitter bars of approximately 75 μm could provide a lower divergence angle of approximately 1 mrad. For example, a smaller transmitter may be used when the light transmission of the objective lenses 502 is high enough at the LRF wavelength, and when the lens aperture is large enough, to overcome the loss of transmitter power while maintaining nominal range performance.

In some embodiments, an illumination transmitter may use the second transmitter aperture 506. To provide operation of the system under very low to no-light conditions, an illuminator may be used. Such low-light or no-light situations do occur, such as in remote locations with overcast night skies where there is no moon or star light available. In these situations, an illuminator may be used, which can direct light toward the view area. Further, the sensors of the optical device 500 can capture optical data associated with the view area. In some embodiments, the illuminator may use a wavelength spectrum outside of the visible wavelength spectrum, for example in nighttime hunting situations. One example spectrum may include infrared light, although other non-visible wavelengths may be used. For example, the visible spectrum extends from approximately 390 nm to 700 nm, and near infrared wavelengths are from approximately 700 nm to 2000 nm. Silicon sensors can detect light from approximately 400-1100 nm wavelengths. Wavelengths outside these ranges may also be used. In some embodiments, different sensors, sensor materials, or different lens materials may be used to effectively receive and capture certain wavelengths.

For example, when using silicon sensors, the waveband of 800-900 nm may be particularly attractive. Silicon is sensitive to this wavelength, and antireflective (AR) coatings on the objective lens may already allow such wavelengths, for example, in the 400-900 nm range. In some embodiments, a wavelength of 830-850 nm may be used for the active illuminator.

In some embodiments, an active illuminator may utilize a low divergence angle and a relatively high brightness. For example, the active illuminator may use laser diode emitters, because light-emitting diode (LED) sources may not be bright enough. In order to improve eye safety with respect to the laser diode and to reduce the effects of speckle, a multi-emitter VCSEL (vertical-cavity surface-emitting laser) array can be implemented. Example VCSEL arrays are available through FLIR® Systems, Inc., of Wilsonville, Oreg. The VCSEL arrays are available with 860 nm center wavelengths, and may be produced at 808 nm, 830 nm, and 850 nm. Other emitters may also be used.

In some embodiments, the illuminator may use a dedicated aperture 506. In some embodiments, divergence angles of 1-3 degrees may be used to match to the image sensor fields of view. If a VCSEL illuminator with an array size of 440 μm is assumed, a 25 mm focal length can provide a 1 degree full angle divergence. The lens may have a fast f-number (e.g. approximately f/1-f/1.5) to efficiently capture the highly divergent laser light. In some embodiments, an aperture diameter of approximately 20-25 mm may be desirable. Further, in some embodiments, the lens may be adjustable to be closer to or farther from the diode to allow automated or user control of the illuminator divergence angle. For example, a user may manually adjust the lens of aperture 506, or the optical device 500 may automatically adjust the lens distance based on a detected strength of illuminator light reflected from objects in the view area.

In some embodiments, active illuminators for night vision may be used at wavelengths of approximately 800-850 nm. This wavelength range matches well to responsivity of silicon while maintaining a relatively simple 400-900 nm AR coating on the objective lenses. In some embodiments, using an active illuminator wavelength (e.g. in the upper 800 nm range) very close to the LRF wavelength (approximately 905 nm) may create complications. For example, reflecting of the LRF wavelength in the LSE while passing the illuminator wavelength through to the night sensor may require a very sharp notch filter coating on the output surface 410 of prism A in FIG. 4. Such a sharp notch filter coating is possible, and sharp transitions can be accomplished using, for example, Rugate filter stacks. However, thermally induced temperature drift of the illuminator may push the illuminator light wavelength longer, making it desirable to provide a longer separation between the wavelengths of interest, such as by keeping the illuminator wavelength in the low 800's, for example. Keeping the separation between frequencies larger allows for a simplified prism coating and provides operational tolerance over a wider temperature range.

FIG. 6 is a block diagram of a system 600 of an optical device having a light separation element, according to some embodiments. The system 600 may represent an implementation of the optical device 100 in FIGS. 1 and 2. The system 600 may include the circuitry 120 and optical sensors 122 of FIG. 1, for example. System 600 can include optical sensors 122 configured to receive light directed through a lens array of the optical device, and separated by an LSE such as the LSE 302 in FIG. 3 or LSE 404 in FIG. 4. System 600 can further include user-selectable elements 604 (such as circuits corresponding to components 114 in FIG. 1) coupled to an input interface 622 of circuitry 120. The optical sensors 122 can transmit a signal proportional to the received light to circuitry 120. In some embodiments, optical sensors 122 may be integrated with circuitry 120.

Circuitry 120 can include a field programmable gate array (FPGA) 612 including one or more inputs coupled to outputs of optical sensors 122. FPGA 612 may further include an input/output interface coupled to a memory 614, which can store data and instructions. FPGA 612 can include a first output coupled to a display 616 (e.g. viewable at eyepiece 102 of FIG. 1) for displaying images, text, other information, or any combination thereof, and a second output coupled to a speaker 617. FPGA 612 may also be coupled to a digital signal processor (DSP) 630 and a micro controller unit (MCU) 634 of an optical device circuit 618. Circuitry 120 can also include sensors 620 configured to measure one or more environmental parameters (such as wind speed and direction, humidity, temperature, incline, elevation, orientation, motion, other parameters, or any combination thereof), and to provide the measurement data to MCU 634. In some embodiments, sensors 620 may include an inclinometer, an accelerometer, an altimeter, a barometer, a thermometer, and other sensor devices.

Circuitry 120 can further include a microphone 628 to capture sounds and to convert the sounds into an electrical signal, which it can provide to an analog-to-digital converter (ADC) 629. ADC 629 may include an output coupled to an input of DSP 630. In some instances, the microphone 628 may be external to circuitry 120 and circuitry 120 may instead include an audio input jack or interface for receiving an electrical signal from microphone 628. In a particular example, the speaker 617 and microphone 628 may be incorporated in a headset worn by a user that is coupled to circuitry 120 through an input/output interface (not shown). DSP 630 can be coupled to a memory 632 and to MCU 634. MCU 634 may be coupled to a memory 636, and to input interface 622. MCU 634 may also be coupled to an LRF or LiDAR circuit 637, an infrared circuit 638, or an illumination circuit 639. The circuitry 120 may also include one or more transceivers 640 for wired or wireless communication with an external device. Further, the circuitry 120 may include an input/output (I/O) interface 635 coupled to the MCU 634 and configured to couple to an external circuit, such as a circuit within the trigger assembly 208 of the firearm 202 in FIG. 2.

In some embodiments, FPGA 612 may be configured to process image data, range finding data, or other data from optical sensors 122. FPGA 612 can process the image data to enhance image quality through digital focusing and gain control. Further, FPGA 612 can perform image registration and stabilization. DSP 630 may execute instructions stored in memory 632 to process audio data from microphone 628 or image data from FPGA 612. In an example embodiment of an optical device that is a firearm scope, as a target moves within the view area, DSP 630 can perform target tracking and can apply a visual marker to the target, which can be shown on display 616. FPGA 612 and DSP 630 may be configured to operate together to perform optical target tracking within the view area of the optical device that incorporates circuitry 120. In some embodiments, the DSP 630 may be configured to combine image data obtained from multiple optical sensors 122 and to provide the combined images to display 616. For example, if the optical device is focused on a dark environment with isolated lighting, image information from a day sensor may be used to display the lighted area, combined with information from the night sensor for the darker areas. Image data from different sensors may be combined in other ways to improve image quality or achieve a desired characteristic or look for an image. For example, a heads-up display (HUD) may be superimposed over a view area image on display 616. The HUD may display information such as a target range, ambient conditions such as wind speed and direction, other information, or any combination thereof.

MCU 634 can process instructions and settings data stored in memory 636 and may be configured to control operation of circuitry 120. FPGA 612 may be configured to operate with MCU 634 to mix the video data with reticle information and target tracking information (from DSP 630) and provide the resulting image data to display 616. In some embodiments, the MCU 634 may switch which optical sensor 122 data to use for creating a display image. In some embodiments, the FPGA 612 or the MCU 634 may compare illumination data from optical sensors 122 to a threshold value, and if the illumination data falls below a threshold, the FPGA 612 or the MCU 634 may alter an operating mode of the optical device, such as switching from a daytime mode to a nighttime mode. For example, the MCU 634 may switch from a “day” setting using data from a daytime sensor to a “night” setting using data from a nighttime sensor if a measured light level falls below a threshold, or if a user changes a display setting manually. The MCU 634 may also be configured to determine when to combine image data from the optical sensors 122 for display. The MCU 634 may be configured to calculate distances using data from the LRF or LiDAR circuit 637, and may use distance data, data from sensor(s) 620, or other information to calculate ballistics information (e.g. a ballistics solution). Further, the MCU 634 may be configured to send control signals through the I/O interface 635 to a circuit of a trigger assembly 208 to control timing of discharge of the firearm.

While FIG. 6 depicts an example embodiment of circuitry 120, at least some of the operations of circuitry 120 may be controlled using one or more general purpose controllers or processor executing programmable instructions. Circuitry 120 may include additional or fewer elements, certain elements may be combined or separated into additional modules, or processes attributed to one component may be executed by another component. Other variations are also possible.

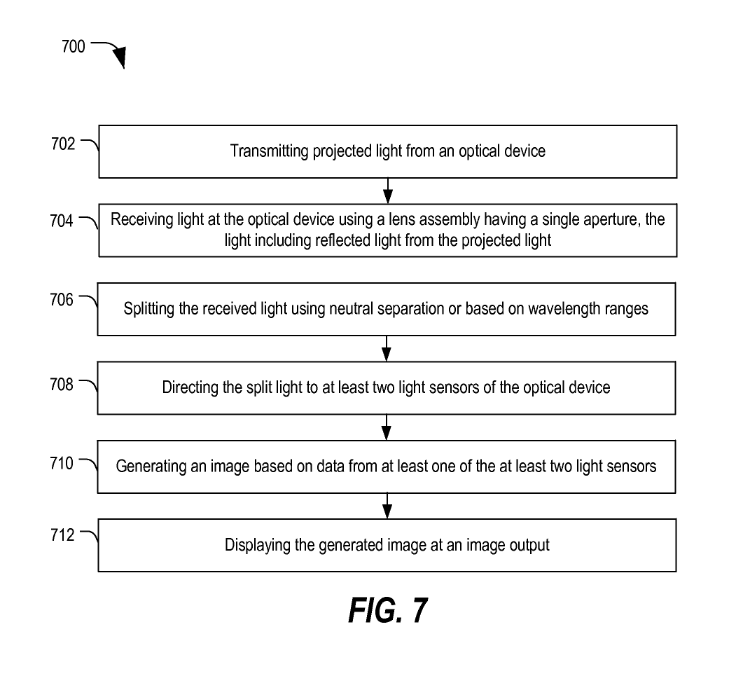

FIG. 7 is a flow chart of a method 700 of receiving light at an optical device having a light separation element according to some embodiments. At 702, the method may include transmitting light from an optical device. For example, this may include emitting a laser beam for LRF purposes, emitting light for LiDAR purposes, illumination on a visible or non-visible wavelength, other forms of light, or any combination thereof. At 704, the method may include receiving light at the optical device through a lens assembly, where the received light includes the reflected light from an object within the view area in response to the transmitted light. For example, an optical device may be used to receive light through a single objective lens assembly. The received light may include natural lighting, as well as reflected laser light for LRF, reflected light from an illuminator, or other light.

At 706, the method may include splitting the received light, for example using a neutral density split, a split based on wavelength ranges, or a combination thereof. For example, the received light may be directed from the lens assembly to a light separate element (LSE). The LSE may include beam splitter cubes or other prisms, light filters, mirrors, or any combination thereof, which may split the received light. The method may include directing the split light in at least two independent beams to at least two light sensors of the optical device, at 708. For example, reflected laser light may be directed to a LRF sensor for calculating a distance to an object or objects, while other light may be directed to one or more other optical sensors.

The method may include generating an image based on data from at least one of the at least two light sensors, at 710. For example, an image may be generated based on data from a daytime sensor when there is sufficient natural lighting. An image may be generated from a nighttime sensor when there is low or no natural lighting. An image may also be generated based on a combination of data from multiple sensors. For example, daytime and nighttime sensor data may be combined when a viewed area has both dark and well-lit areas. In another embodiment, individual sensors may be used for red, green, and blue light wavelengths, and the received data may be combined into a single image based on all three sensors. LRF or LiDAR data may be used to calculate distances, calculate ballistics data, to supplement the image with additional depth information or distance data, or any combination thereof. Other combinations are also possible. Images and other information generated based on data received at the sensors may be provided to a display of the optical device, such as at an eyepiece or screen display, at 712.

The above circuits, systems, and methods may be directed to telescopes, binoculars, cameras, or other optical devices. Similarly, steps of the methods may be performed by other device elements than those described, or some elements may be combined or eliminated without departing from the scope of the present disclosure.

While the present invention has been described with reference to preferred embodiments, workers skilled in the art will recognize that changes may be made in form and detail without departing from the scope of the present disclosure. In accordance with various embodiments, the methods described herein may be implemented as one or more software programs running on a computer processor or controller. Dedicated hardware implementations including, but not limited to, application specific integrated circuits, programmable logic arrays, and other hardware devices can likewise be constructed to implement the methods described herein. Further, the methods described herein may be implemented as a computer readable storage device or memory device including instructions that, when executed, cause a processor to perform the methods.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
an optical device including:
an aperture to receive light;
a light separation element (LSE) configured to separate the light received from the aperture into at least a first light output directed to a bright light sensor and a second light output directed to a low light sensor;
circuitry configured to:
generate first image data based on the first light output at the bright light sensor; and
generate second image data based on the second light output at the low light sensor.

2. The apparatus of claim 1, wherein the optical device comprises a firearm scope.

3. The apparatus of claim 2, wherein:
the LSE is further configured to separate the light received from the aperture into a range-based light output directed to a range sensor;
the circuitry is further configured to:
determine range data based on the range-based light output at the range sensor; and
perform ballistics calculations using the range data.

4. The apparatus of claim 3, further comprising a laser range finder transmitter to transmit a laser beam toward a view area of the optical device, wherein the range-based light output is reflected light from an object in the view area.

5. The apparatus of claim 3, further comprising a light detection ranging (LiDAR) transmitter, wherein the range-based output is reflected light from an object in a view area of the optical device, the reflect light having been transmitted from the LiDAR transmitter.

6. The apparatus of claim 1, wherein the LSE includes a prism assembly.

7. The apparatus of claim 1, wherein the LSE is configured to:
separate the light using neutral density light separation;
direct a first portion of the light to the low light sensor;
direct a second portion of the light to the bright light sensor; and
wherein the first portion is greater than the second portion.

8. The apparatus of claim 1, wherein the circuitry is further configured to generate image data based on a combination of the first image data and the second image data.

9. The apparatus of claim 1 further comprising:
an illumination transmitter to direct light toward a view area; and
wherein the second light output is light reflected from an object in a view area of the optical device.

10. The apparatus of claim 1, wherein the LSE is configured to separate the light based on wavelength spectrums.

11. The apparatus of claim 10, wherein the LSE is configured to separate the light using neutral density light separation and wavelength spectrums.

12. The apparatus of claim 1, wherein the aperture is adjustable to modify an amount of light separated by the LSE.

13. A firearm scope comprising:
a range-finder transmitter configured to transmit light toward a view area;
an aperture configured to receive light, including reflected light from an object within the view area;
a light separation element (LSE) configured to:
separate the received light into at least a first light portion and a second light portion;
direct the first light portion to a range-finder sensor; and
direct the second light portion to a first imaging sensor.

14. The firearm scope of claim 13, further comprising:
circuitry configured to:
determine range data based on the first light portion at the range-finder sensor;
perform a ballistics calculation using the range data; and
control an operation of a firearm based on the ballistics calculation.

15. The firearm scope of claim 13, further comprising circuitry configured to:
generate image data based the second light portion at the first imaging sensor; and
provide at least a portion of the image data to a display.

16. The firearm scope of claim 13, wherein:
the LSE comprises a prism assembly; and
the prism assembly is configured to further separate the received light into a third light portion directed to a second imaging sensor.

17. The firearm scope of claim 16, wherein the first imaging sensor has more pixels and a smaller pixel pitch than the second imaging sensor.

18. The firearm scope of claim 16, wherein the LSE includes a neutral density filter to direct a first quantity of the received light to the first imaging sensor and a second quantity of the received light to the second imaging sensor, wherein the second quantity is larger than the first quantity.

19. The firearm scope of claim 16, wherein:
the first imaging sensor is sensitive to a first wavelength spectrum and the second light portion includes light in the first wavelength spectrum; and
the second imaging sensor is sensitive to a second wavelength spectrum and the third light portion includes light in the second wavelength spectrum.

20. The firearm scope of claim 19, wherein:
the second wavelength spectrum includes the first wavelength spectrum and a third wavelength spectrum;
the LSE is further configured to:
direct a larger portion of the first wavelength spectrum to the second imaging sensor;
direct a smaller portion of the first wavelength to the first imaging sensor; and
direct the third wavelength spectrum to the second imaging sensor.

21. The firearm scope of claim 16 further comprising:
an infrared illumination transmitter to illuminate the view area; and
wherein the third light portion includes reflected infrared light from an object in the view area.

22. A method comprising:
transmitting light at a selected frequency from a transmitter of a firearm scope toward a view area of the firearm scope;
receiving light at the firearm scope from the view area through an aperture, the received light including reflected light corresponding to the light of the selected frequency reflected by an object in the view area;
separating the received light into a first output portion and a second output portion, the first output portion including the reflected light;
directing the first output portion to a first sensor and the second output portion to a second sensor;
generating image data based on data from the second sensor; and
providing the image data to a display of the firearm scope.

23. The method of claim 22 further comprising:
generating target range data based on a signal from the first sensor in response to the first output portion;
separating a third output portion from the second output portion and directing the third output portion to a third sensor;
generating daytime image data from the second output portion at the second sensor; and
generating low-light image data from the third output portion at the third sensor.
